(19) United States
(12) Patent Application Publication
(10) Pub. No.: US 2015/0017609 A1
(43) Pub. Date: Jan. 15, 2015

(54) METHOD AND APPARATUS FOR GENERATING OR UPDATING AN AVIATION SIMULATION SCENARIO

(71) Applicant: General Electric Company, Schenectady, NY (US)

(72) Inventors: Bruno Paes Leao, Rio de Janeiro (BR); Joel Kenneth Klooster, Seattle, WA (US); Gabriel de Albuquerque Gleizer, Rio de Janeriro (BR)

(21) Appl. No.: 13/938,034

(22) Filed: Jul. 9, 2013

(51) Int. Cl. G09B 9/08

(52) U.S. Cl. CPC G09B 9/08
USPC 434/30

(57) ABSTRACT

Method and apparatus for generating or updating (e g , tuning) an aviation simulation scenario. One method for generating an aviation simulation scenario includes receiving user input corresponding to the aviation simulation scenario at a processing device. The method also includes accessing one or more input data sources collectively having multiple data sets using the processing device. The method includes transforming data sets into the aviation simulation scenario using the processing device based on the user input. The method also includes storing the aviation simulation scenario. The aviation simulation scenario is configured to be provided to an aviation simulator software for executing an aviation simulation.

### BACKGROUND

The subject matter disclosed herein relates generally to aviation simulation and, more specifically, to methods and apparatuses for generating or updating an aviation simulation scenario.

Various aviation simulations may be performed to simulate aviation operation. For example, air traffic control simulations, aircraft operator simulations, and/or airport simulations may be performed. These simulations use scenarios that are generated using data from various sources. For example, scenarios may be generated using wind data, weather grid data, meteorological terminal aviation routine weather report (METAR) data, aircraft navigation data, repetitive flight plan (RPL) data, flight traffic history data, aircraft operations data, airport operations data, and so forth. The data from the various sources is processed to generate a scenario format. In certain arrangements, the data is manually entered into a scenario generation software to generate the scenarios. Unfortunately, generating such scenarios via manual data input may be time consuming, error-prone, and/or inefficient.

### BRIEF DESCRIPTION

In one embodiment, a method for generating an aviation simulation scenario includes receiving user input corresponding to the aviation simulation scenario at a processing device. The method also includes accessing one or more input data sources collectively having multiple data sets using the processing device. The method includes transforming data sets into the aviation simulation scenario using the processing device based on the user input. The method also includes storing the aviation simulation scenario. The aviation simulation scenario is configured to be provided to an aviation simulator software for executing an aviation simulation.

In another embodiment, a method for updating an aviation simulation scenario includes receiving output metrics data from an aviation simulator software at a processing device. The aviation simulation software uses the aviation simulation scenario. The method also includes determining actual metrics data at the processing device. The method includes comparing the output metrics data to the actual metrics data using the processing device to determine a difference between the output metrics data and the actual metrics data.

In a further embodiment, an apparatus includes at least one tangible, machine-readable media having instructions encoded thereon for execution by a processor. The instructions include instructions to receive user input corresponding to an aviation simulation scenario and instructions to access one or more input data sources collectively having multiple data sets. The instructions also include instructions to transform the data sets into the aviation simulation scenario using the processing device based on the user input. The aviation simulation scenario is configured to be provided to an aviation simulator software for executing an aviation simulation.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a system for performing, creating, and/or updating aviation simulations;

FIG. 2 is a block diagram of an embodiment of data flow in a processing device used to generate simulation scenarios;

FIG. 3 is a block diagram of an embodiment of a simulation design and validation software;

FIG. 4 is a flow chart of an embodiment of a method for tuning simulation parameters;

FIG. 5 is a flow chart of an embodiment of a method for generating an aviation simulation scenario;

FIG. 6 is a flow chart of an embodiment of a method for updating an aviation simulation scenario; and

FIG. 7 is a screenshot of an embodiment of a graphical user interface (GUI) of a simulation design and validation software.

### DETAILED DESCRIPTION

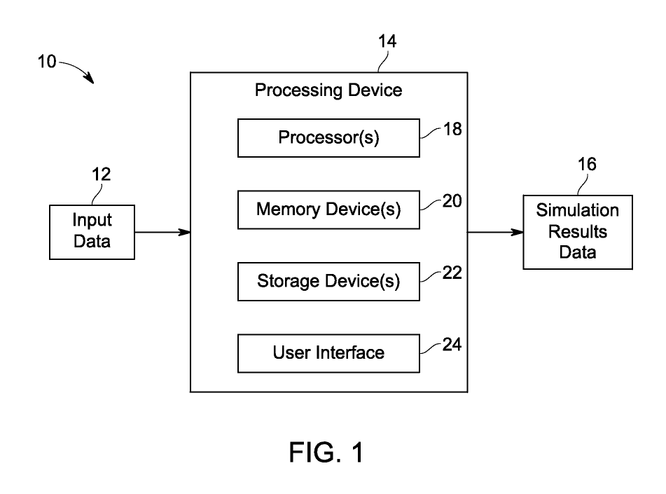

FIG. 1 is a block diagram of an embodiment of a system 10 for performing creating, and/or updating aviation simulations. The system 10 may be configured to perform any suitable aviation simulation. For example, the system 10 may be configured to perform air traffic control simulations, aircraft operator simulations, and/or airport simulations. Input data 12 is provided to a processing device 14, which is used to execute one or more simulations using the input data 12. The input data 12 may be any data suitable for generating aviation simulation scenarios. For example, the input data 12 may include wind data (e.g., time-ordered wind data), temperature data (e.g., temperature aloft data), weather data (e.g., weather grid data), meteorological terminal aviation routine weather report (METAR) data, aircraft navigation data (e.g., ARINC 424 databases), repetitive flight plan (RPL) data, aircraft and/or airport operations data (e.g., passenger statistics, cargo statistics, ground support equipment (GSE) usage, etc.), world area forecast system (WAFS) data, areas of turbulence data, convective weather zone data, flight plans from aircraft operators, air navigation service providers (ANSPs) data, planned flight arrival and departure times, actual flight arrival and departure times, reasons for delays, radar data (e.g., radar tracks), automatic dependent surveillance-broadcast (ADS-B) data, actual flown trajectory data, data stored on aircraft recorders, navigation charts, airport data, gate data, taxiway data, runway data, airport mapping database (AMDB) data, usage statistics of an airport infrastructure, air traffic control rules data, air traffic control procedure data, maintenance data, crew data, passenger data, cargo data, and so forth. The input data 12 may be provided to the processing device 14 in a variety of standard and/or non-standard data formats (e.g., binary files, text files, spreadsheets, databases, etc.), and the data may include varying levels of detail. Moreover, the input data 12 may include one or more data sets (e.g., types of data, groups of data, etc.). The processing device 14 transforms the input data 12 into one or more simulation scenarios. Furthermore, the processing device 14 executes one or more simulations using the simulation scenarios and outputs simulation results data 16 that may be used to analyze the one or more simulations.

The processing device 14 includes one or more processors 18, memory devices 20, and storage devices 22. The processor(s) 18 may be used to execute software, such as scenario generation software, simulation software, and so forth. Moreover, the processor(s) 18 may include one or more microprocessors, such as one or more “general-purpose” microprocessors, one or more special-purpose microprocessors and/or application specific integrated circuits (ASICS), or some combination thereof. For example, the processor(s) 18 may include one or more reduced instruction set (RISC) processors.

The memory device(s) 20 may include a volatile memory, such as random access memory (RAM), and/or a nonvolatile memory, such as read-only memory (ROM). The memory device(s) 20 may store a variety of information and may be used for various purposes. For example, the memory device(s) 20 may store processor-executable instructions (e.g., firmware or software) for the processor(s) 18 to execute, such as instructions for scenario generation software, simulation software, and so forth.

The storage device(s) 22 (e.g., nonvolatile storage) may include ROM, flash memory, a hard drive, or any other suitable optical, magnetic, or solid-state storage medium, or a combination thereof. The storage device(s) 22 may store data (e.g., input data 12, simulations results data 16, etc.), instructions (e.g., software or firmware for scenario generation, simulations, etc.), and any other suitable data.

The processing device 14 includes a user interface 24. The user interface 24 enables an operator to input parameters associated with the input data 12 (e.g., the type of data, the format of the data, etc.). The user interface 24 also enables an operator to select options that define the scope of a scenario (e.g., restricting the scenario to a specific day, restricting the scenario to a specific portion of airspace, restricting the scenario to a specific set of airdromes, restricting the scenario to a type of aircraft traffic, defining a degree of fidelity, selecting scenario features to be included or restricted, such as weather, and so forth). As may be appreciated, the user interface 24 may include a keyboard, a mouse, or any suitable device for inputting data, making selections, and/or operating the processing device 14. Furthermore, the user interface 24 may include a display to present data, such as the simulation results data 16. The user interface 24 may also include a printer for printing data, such as for printing simulation results data 16.

The processing device 14 may include software configured to receive the input data 12 from various sources (e.g., extract the input data 12 from various files), process the input data 12 (e.g., convert, format, and/or merge the data), and generate one or more scenario files (e.g., an air traffic simulation scenario, an aircraft operator simulation scenario, an airport simulation scenario, etc.) for a software simulation. The processing device 14 may also include software configured to provide outputs, including a set of user configurable metrics and/or graphical representations associated with the input data 12 (e.g., based on real world historical data, data from a validated model, etc.). Moreover, the processing device 14 may be configured to validate scenarios by comparing outputs from simulations (e.g., simulation results data) with actual aviation data (e.g., input data 12). As may be appreciated, using the processing device 14, simulation scenarios may be generated and/or validated quickly and/or efficiently. While the processing device 14 is described in the illustrated embodiments, other embodiments may use one or more processing devices to generate simulation scenarios, execute simulations, and/or validate simulation scenarios.

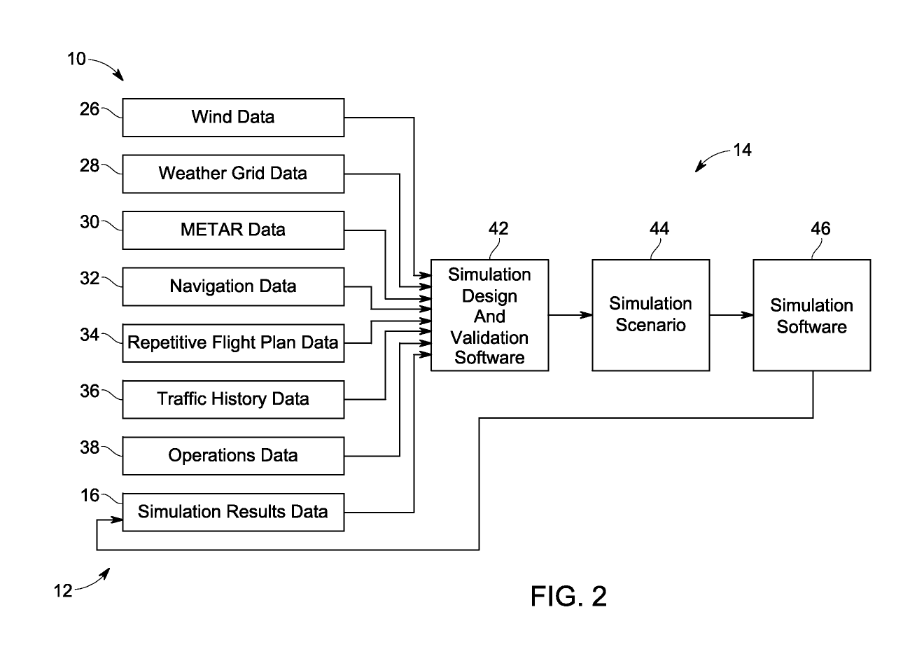

FIG. 2 is a block diagram of an embodiment of data flow in a processing device used to generate simulation scenarios. As illustrated, the input data 12 may include wind data 26 (e.g., wind data from the National Oceanic and Atmospheric Administration (NOAA)), weather grid data 28, METAR data 30 (e.g., from NOAA), aircraft navigation data 32 (e.g., from embedded aircraft computers), RPL data 34, flight traffic history data 36, operations data 38 (e.g., aircraft, airport, and/or airline operations data), and the simulations results data 16 (e.g., to facilitate validating and/or tuning the simulation scenario).

The input data 12 is provided to a simulation design and validation software 42. The simulation design and validation software 42 may be configured to extract the input data 12 from one or more files, process the input data 12, and output one or more files that contain data representative of a simulation scenario 44 (e.g., air traffic simulation scenario, aircraft operator simulation scenario, airport simulation scenario, etc.), thereby facilitating quick, accurate, and/or efficient generation of the simulation scenario 44. An operator may provide input to the simulation design and validation software 42 to at least partially control extraction and/or processing of the input data 12. Furthermore, operator input enables selection of parameters that relate to a specific simulation scenario 44. After the simulation scenario 44 is generated, the simulation scenario 44 is provided to a simulation software 46. The simulation software 46 performs a simulation (e.g., air traffic simulation, aircraft operator simulation, airport simulation, etc.) using the generated simulation scenario 44. As illustrated, the simulation software 46 outputs the simulation results data 16, which is provided to the simulation design and validation software 42.

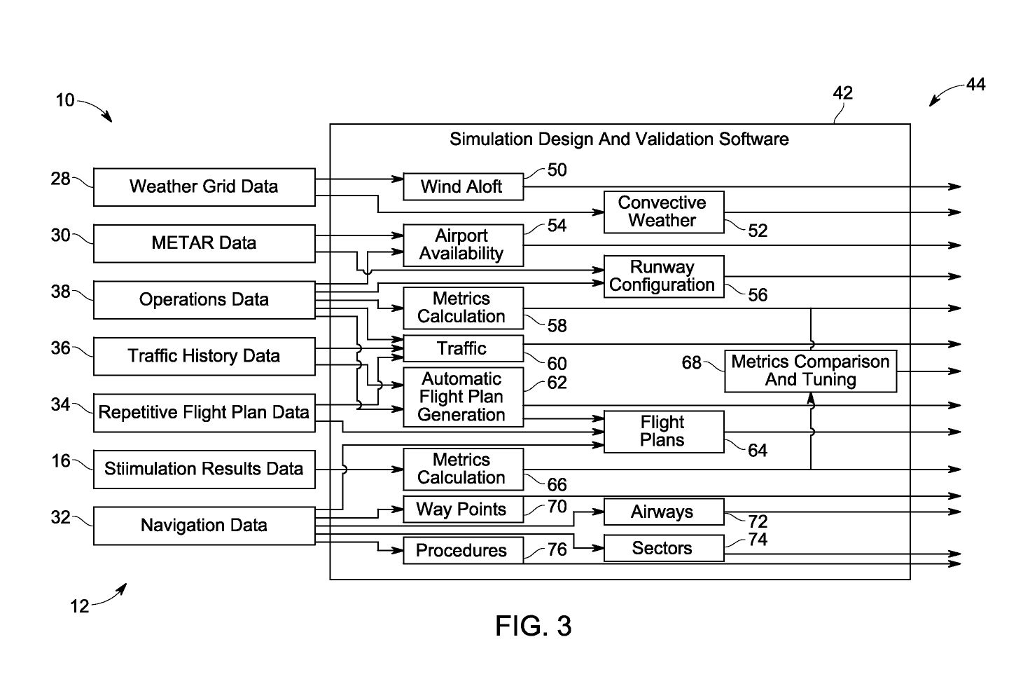

FIG. 3 is a block diagram of an embodiment of the simulation design and validation software 42. In the illustrated embodiment, the input data 12 is provided to the simulation design and validation software 42, and the simulation design and validation software 42 outputs multiple files that collectively contain the simulation scenario 44. Moreover, the multiple files output from the simulation design and validation software 42 are based on user input corresponding to a desired simulation scenario. For example, the user input may include a simulation time of day, a simulation airport, a simulation location, and so forth. As may be appreciated, the illustrated input data 12 and the illustrated data output to the simulation scenario 44 are representative examples of data associated with the simulation design and validation software 42. Accordingly, in the illustrated embodiment, the simulation design and validation software 42 uses (e.g., processes, analyzes, scales, converts, normalizes, standardizes, etc.) the weather grid data 28 to generate wind aloft data 50 and convective weather data 52. Moreover, the illustrated embodiment of the simulation design and validation software 42 uses the METAR data 28 and the operations data 38 to generate airport availability data 54. The illustrated embodiment of the simulation design and validation software 42 uses the METAR data 30 and the operations data 38 to generate runway configuration data 56. Furthermore, the illustrated embodiment of the simulation design and validation software 42 uses the operations data 38 to generate metrics calculation data 58.

In addition, the simulation design and validation software 42 uses the operations data 38, the traffic history data 36, and/or the RPL data 34 to generate traffic data 60. Moreover, the simulation design and validation software 42 uses the operations data 38 and the traffic history data 36 to automatically generate flight plan generation data 62. The simulation design and validation software 42 uses the automatic flight plan generation data 62, the RPL data 34, and the navigation data 32 to generate flight plans 64. Furthermore, the simulation design and validation software 42 uses the simulation results data 16 to generate metrics calculation data 66. The metrics calculation data 58 and 66 are used to generate metrics comparison and tuning data 68. In addition, the navigation data 32 is used to generate waypoints data 70, airways data 72, sectors data 74, and procedures data 76. As may be appreciated, the data generated by the simulation design and validation software 42 may be provided to one or more data files, to a software interface (e.g., a software bot, a communication middleware, a DLL, etc.), or to any suitable hardware and/or software to collectively contain the simulation scenario 44. Thus, the simulation design and validation software 42 may efficiently generate the simulation scenario 44 by accessing files containing the input data 12 and outputting files collectively containing the simulation scenario 44 without manually inputting the input data 12.

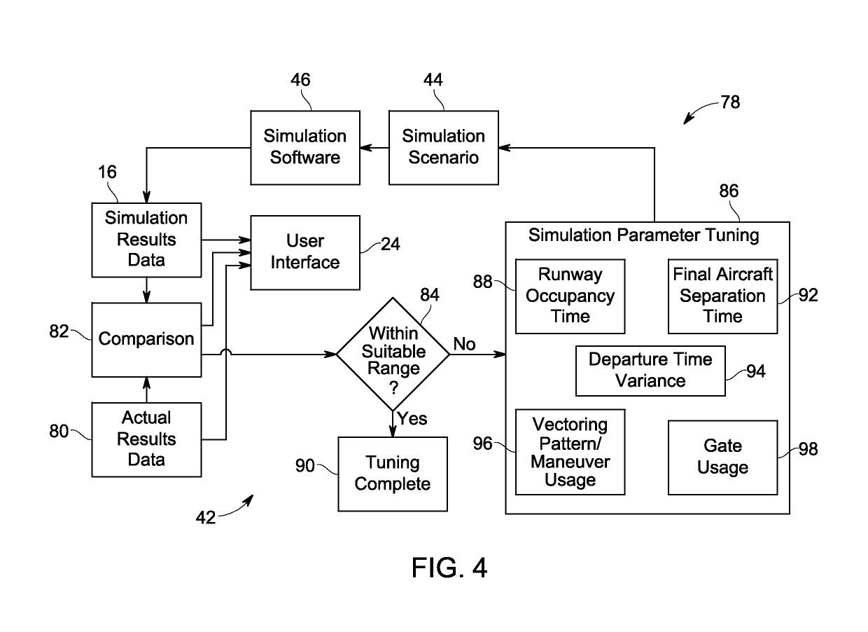

FIG. 4 is a flow chart of an embodiment of a method 78 for tuning simulation parameters. As illustrated, the simulation scenario 44 is provided to the simulation software 46. The simulation software 46 performs a simulation using the simulation scenario 44 and outputs the simulation results data 16. As may be appreciated, the simulation results data 16 may include any suitable configurable metric. For example, the simulated results data 16 may include a time that aircraft for each flight are in a terminal area (TMA), an amount of excess distance/time from vectoring or holding maneuvers, a controller workload measured by a number of tactical flight adjustments, an average number of aircraft in the terminal area in a given time block, a maximum number of aircraft in the terminal area in a given time block, movements (e.g., per hour) on an airport, runway, and/or sector, a four-dimensional trajectory compliance to flight tracks, a time in each phase of the flight, a total time of the flight, overall delays, etc. The simulation design and validation software 42 compares each parameter from actual results data 80 with each respective parameter from the simulation results data 16 (block 82). For example, an actual time that aircraft for each flight are in the TMA may be compared with the simulated results. As part of the comparison, the simulation design and validation software 42 may generate an average difference in time that aircraft for each flight are in the TMA. The actual results data 80 may include any portion of the input data 12 used to generate the simulation scenario 44, input data 12 that has been formatted and/or transformed by the simulation design and validation software 42, or any other suitable aviation related data (e.g., metrics data). The simulation results data 16, the actual results data 80, and/or the comparison 82 may be provided to an operator via the user interface 24.

The simulation design and validation software 42 determines whether the results of the comparison are within a suitable range (block 84). For example, the simulation design and validation software 42 may determine whether the average difference in the time that aircraft for each flight are in the TMA is within a lower and an upper predetermined threshold. If the result of the comparison of at least one of the parameters is not within a suitable range, simulation parameter tuning is performed by the simulation design and validation software 42 on the at least one of the parameters (block 86). For example, a parameter corresponding to time in the TMA may be adjusted (e.g., runway occupancy time (ROT) 88—the time an aircraft is on a runway). In contrast, if the results of the comparison are all within a suitable range, tuning is complete (block 90). Returning to block 86, specific parameters may be tuned within block 86, such as the ROT 88, final aircraft separation time 92, departure time variance 94 (e.g., a difference between a planned departure time and an actual departure time), vectoring pattern/maneuver usage 96, and gate usage 98 (e.g., a percentage of time that a terminal gate is used). In certain embodiments, any suitable parameters may be tuned within block 86, such parameters may include air traffic control conflict resolution rules, aircraft speeds, departure procedure assignment rules, approach procedure assignment rules, and/or any other parameters described herein. After parameters are tuned, the simulation design and validation software 42 modifies the simulation scenario 44 to include the updated parameters. The simulation software 46 may perform a simulation using the modified simulation scenario 44, and the cycle repeats until tuning is complete (block 90). In some embodiments, the cycle may only repeat for a predetermined maximum number of iterations. Accordingly, the simulation scenario 44 may be tuned, such as by using the simulation design and validation software 42. As may be appreciated, while one specific iterative process is described herein, any suitable optimization technique and/or machine learning may be used.

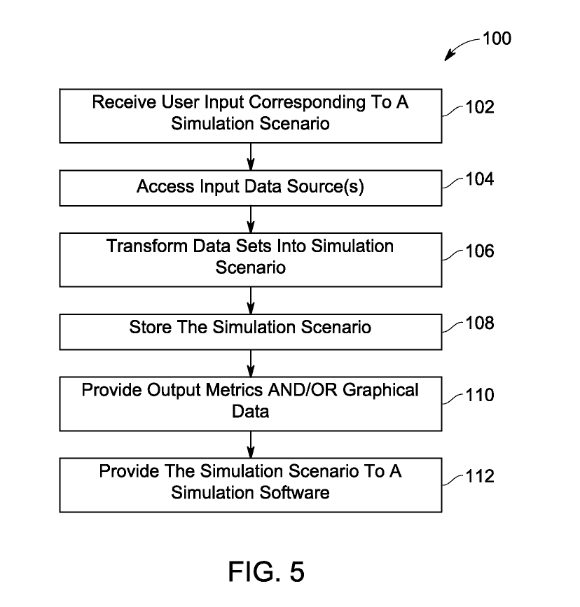

FIG. 5 is a flow chart of an embodiment of a method 100 for generating an aviation simulation scenario. The processing device 14 receives user input (e.g., via the user interface 24) corresponding to a simulation scenario (e.g., the aviation simulation scenario) (block 102). The user input may be used to define input data sources and formats, the scope of a scenario (e.g., restricting the scenario to a specific day, restricting the scenario to a type of aircraft traffic, defining a degree of fidelity, selecting scenario features to be included or restricted, such as weather, and so forth), and/or an output format for scenario creation, metrics calculation, outputs and/or metrics visualization, etc. The processing device 14 accesses one or more input data sources (e.g., data files) collectively having multiple data sets (block 104). The multiple data sets may include any suitable data, such as the input data 12 (e.g., meteorological data, aircraft navigation data, aircraft operation data, historic air traffic data, etc.). The one or more input data sources may include data that is in different formats (e.g., text file data, binary files, databases, electronic spreadsheets, etc.). Moreover, the processing device 14 may access the input data sources using the simulation design and validation software 42. The processing device 14 transforms (e.g., formats, processes, combines, etc.) the data sets into the simulation scenario based on the user input (block 106). For example, the processing device 14 may transform the data sets into the simulation scenario 44 using the simulation design and validation software 42, or any suitable software.

The processing device 14 stores the simulation scenario, such as in one or more output data files, or in any suitable storage arrangement (block 108). The simulation scenario is configured to be provided to an aviation simulator software for executing an aviation simulation. The processing device 14 outputs metrics and/or graphical data corresponding to the simulation scenario (block 110). In certain embodiments, the simulation scenario is provided to a simulation software (block 112). For example, the simulation scenario may be provided to the aviation simulator for executing the aviation simulation. As may be appreciated, the method 100 may be performed by the processor(s) 18 executing software instructions stored on the memory device(s) 20 and/or the storage device(s) 22. Furthermore, although the processing device 14 is described as performing the method 100, the method 100 may be performed using any suitable device.

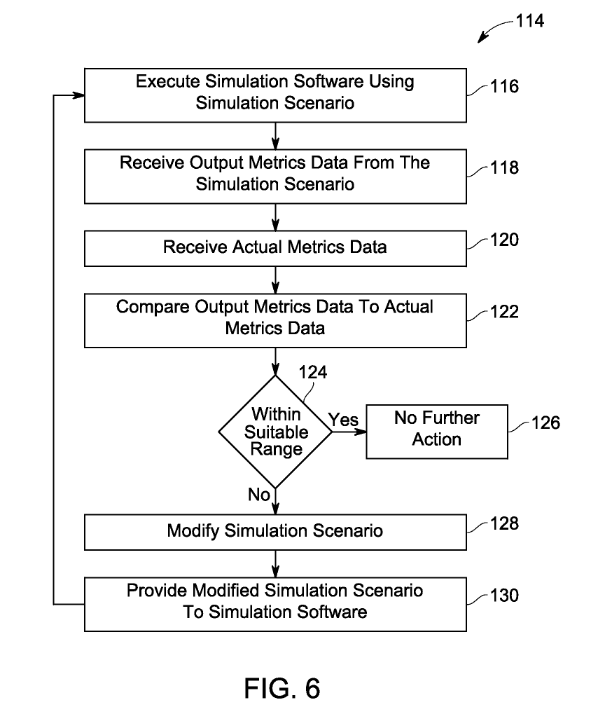

FIG. 6 is a flow chart of an embodiment of a method 114 for updating an aviation simulation scenario. The processing device 14 (or another device) executes simulation software (e.g., air traffic simulation software) using a simulation scenario (e.g., air traffic simulation scenario) to generate output metrics data (block 116). The output metrics data may include any suitable data, such as a ROT, a final aircraft separation time, a departure time variance, conflict occurrences, a maneuver usage, a gate usage, a gate occupancy, an amount of excess distance/time from vectoring or holding maneuvers, a controller workload measured by a number of tactical flight adjustments, an average number of aircraft in the terminal area in a given time block, a maximum number of aircraft in the terminal area in a given time block, movements (e.g., per hour) on an airport, runway, and/or sector, four-dimensional trajectory compliance to flight tracks, time in each phase of the flight, total time of the flight, overall delays, a distance, a time, a fuel consumption, and so forth. The processing device 14 receives the output metrics data from the simulation software (block 118). Moreover, the processing device 14 also receives actual metrics data (block 120). The actual metrics data may be extracted from the input data 12, may be additional input data 12 (e.g., covering a different time period), may be formed (e.g., created, formatted, and/or transformed) by the simulation design and validation software 42, or may be any suitable data. The processing device 14 compares each parameter of the output metrics data to each respective parameter of the actual metrics data to determine a difference between each parameter of the output metrics data and each respective parameter of the actual metrics data (block 122). In certain embodiments, the processing device 14 may generate comparison metrics and/or graphical representations of the comparison to facilitate validating and/or visualizing the comparisons. The processing device 14 determines whether the differences between each parameter of the output metrics data and each respective parameter of the actual metrics data is within a lower and an upper predetermined thresholds (e.g., suitable range) (block 124). If the difference between each parameter of the output metrics data and each respective parameter of the actual metrics data is within the lower and the upper predetermined thresholds, no further action is performed to update the aviation simulation scenario for the parameters (block 126).

However, if the difference between any of the parameters of the output metrics data and the respective parameter of the actual metrics data is not within the lower and the upper predetermined thresholds (e.g., or greater than the respective threshold value), the simulation scenario is modified (block 128). The modified simulation scenario is provided to the simulation software (block 130). In certain embodiments, the method 114 then returns to block 116 where the method 114 is repeated until all of the parameters of the metrics data are within their respective lower and upper predetermined thresholds. Moreover, in other embodiments, the method 114 may repeat a predetermined number of times, repeat a predetermined maximum number of times, operate on multiple parameters in parallel, or repeat and/or function in any suitable manner. While the processing device 14 has been described herein as processing data and/or executing various software to perform the method 114, any suitable processing device or processing devices may be used to perform the method 114. For example, cloud computing may be used to provide remote and/or parallel processing. Furthermore, while certain computational and/or optimization techniques have been described herein, any suitable computational and/or optimization techniques may be used.

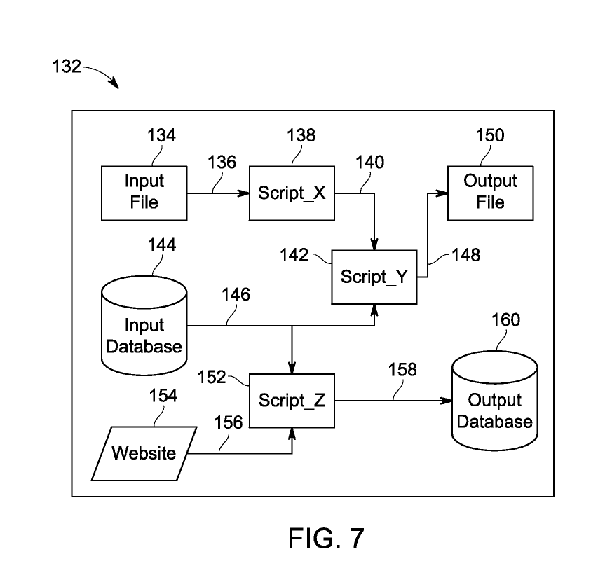

FIG. 7 is a screenshot 132 of an embodiment of a graphical user interface (GUI) of the simulation design and validation software 42. The GUI is designed to facilitate displaying a visual representation of the data flow and data processing completed by the simulation design and validation software 42. Various blocks are displayed as part of the screenshot 132. Each block may include parameters associated with the block that define data formats, data locations, data properties, data conditioning, data sources, data destinations, and so forth. In the illustrated embodiment, a representation of an input file 134 is displayed on a screen. The representation of the input file 134 represents one form of input data 12 provided to the simulation design and validation software 42. The representation of the input file 134 may be associated with any suitable parameters corresponding to the input data 12. An output 136 from the representation of the input file 134 is graphically illustrated as being provided to a script_x 138. The script_x 138 performs processing on the output 136. The processing may be performed using any suitable processor, which may be defined in the parameters associated with the script_x 138. For example, the processing may be performed by executing software and/or a script on a local device (e.g., a device to which the screen is coupled), an external device, and/or a remote device, such as devices connected through a network (e.g., the Internet).

An output 140 from the script_x 138 is provided to a script_y 142. Furthermore, a representation of an input database 144 provides an output 146 to the script_y 142. The representation of the input database 144 represents another form of input data 12 provided to the simulation design and validation software 42. The representation of the input database 144 may be associated with any suitable parameters corresponding to the input data 12. The script_y 142 performs processing on the outputs 140 and 146. The processing may be performed using any suitable processor, which may be defined in the parameters associated with the script_y 142. For example, the processing may be performed by executing software and/or a script on a local device (e.g., a device to which the screen is coupled), an external device, and/or a remote device, such as devices connected through a network (e.g., the Internet). An output 148 from the script_y 142 is provided to a representation of an output file 150. The representation of the output file 150 represents at least a portion of the simulation scenario 44 produced by the simulation design and validation software 42. The representation of the output file 150 may be associated with any suitable parameters corresponding to the simulation scenario 44.

The output 146 is also provided to a script_z 152. Furthermore, a representation of a website 154 provides an output 156 to the script_z 152. The representation of the website 154 represents another form of input data 12 provided to the simulation design and validation software 42. The representation of the website 154 may be associated with any suitable parameters corresponding to the input data 12. The script_z 152 performs processing on the outputs 146 and 156. The processing may be performed using any suitable processor, which may be defined in the parameters associated with the script_z 152. For example, the processing may be performed by executing software and/or a script on a local device (e.g., a device to which the screen is coupled), an external device, and/or a remote device, such as devices connected through a network (e.g., the Internet). An output 158 from the script_z 152 is provided to a representation of an output database 160. The representation of the output database 160 represents at least a portion of the simulation scenario 44 produced by the simulation design and validation software 42. The representation of the output database 160 may be associated with any suitable parameters corresponding to the simulation scenario 44. As may be appreciated, the illustrated screenshot 132 represents one example of graphically displaying input data 12 and data corresponding to a simulation scenario 44 to an operator. It should be noted that graphical representations may be rearranged, added, removed, changed, and so forth, based on a configuration desired by the operator in order to process input data 12 to produce a simulation scenario 44.

Technical effects of the invention include efficiency and/or accuracy in developing and validating simulation scenarios. Accordingly, costs to develop and/or validate simulation scenarios may be reduced. For example, one or more software programs may facilitate efficient simulation scenario preparation, simulation scenario validation, and/or simulation of air traffic, aircraft operations, and/or airport operations scenarios.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for generating an aviation simulation scenario, comprising:
receiving user input corresponding to the aviation simulation scenario at a processing device;
accessing one or more input data sources collectively comprising a plurality of data sets using the processing device;
transforming the plurality of data sets into the aviation simulation scenario using the processing device based on the user input; and
storing the aviation simulation scenario;
wherein the aviation simulation scenario is configured to be provided to an aviation simulator software for executing an aviation simulation.

2. The method of claim 1, wherein the plurality of data sets comprises at least one of meteorological data, aircraft navigation data, and aircraft operations data.

3. The method of claim 1, comprising providing the aviation simulation scenario to the aviation simulator software for executing the aviation simulation.

4. The method of claim 1, comprising generating output metrics, graphical data, or some combination thereof, using the processing device based on the user input.

5. The method of claim 1, wherein the user input comprises a simulation time of day restriction, an airspace restriction, an airport setting, an aircraft restriction, a precision restriction, a simulation data restriction, a data source definition, a data source format, outputs for the aviation simulation scenario, a metrics calculation to be performed, a visualization to be produced, or some combination thereof.

6. The method of claim 1, wherein the one or more input data sources comprises a plurality of input data sources.

7. The method of claim 6, wherein the plurality of input data sources comprises a first data source in a first format and a second data source in a second format different from the first format.

8. A method for updating an aviation simulation scenario, comprising:
receiving output metrics data from an aviation simulator software at a processing device, wherein the aviation simulation software uses the aviation simulation scenario;
determining actual metrics data at the processing device; and
comparing the output metrics data to the actual metrics data using the processing device to determine a difference between the output metrics data and the actual metrics data.

9. The method of claim 8, comprising modifying the aviation simulation scenario using the processing device to produce a modified aviation simulation scenario if the difference between the output metrics data and the actual metrics data is not within predetermined threshold limits.

10. The method of claim 8, comprising executing the aviation simulation software using the aviation simulation scenario to produce the output metrics data.

11. The method of claim 9, comprising providing the modified aviation simulation scenario to the aviation simulation software, and executing the aviation simulation software using the modified aviation simulation scenario to produce modified output metrics data.

12. The method of claim 11, comprising:
receiving the modified output metrics data from the aviation simulator software at the processing device; and
comparing the modified output metrics data to the actual metrics data using the processing device to determine a second difference between the modified output metrics data and the actual metrics data.

13. The method of claim 12, comprising modifying the modified aviation simulation scenario using the processing device to produced a second modified aviation simulation scenario if the difference between the modified output metrics data and the actual metrics data is not within the predetermined threshold limits.

14. The method of claim 8, wherein the output metrics data comprises data corresponding to at least one of a runway occupancy time, a final aircraft separation time, a departure time variance, conflict occurrence, a maneuver usage, a gate usage, an amount of excess distance or time from vectoring or holding maneuvers, a controller workload measured by a number of tactical flight adjustments, an average number of aircraft in the terminal area in a given time block, a maximum number of aircraft in the terminal area in a given time block, movements on an airport, runway, or sector, a four-dimensional trajectory compliance to flight tracks, a time in each phase of the flight, a total time of the flight, overall delays, a distance, a time, and a fuel consumption.

15. An apparatus comprising:
at least one tangible, machine-readable media having instructions encoded thereon for execution by a processor, the instructions comprising:
instructions to receive user input corresponding to an aviation simulation scenario;
instructions to access one or more input data sources collectively comprising a plurality of data sets; and
instructions to transform the plurality of data sets into the aviation simulation scenario using the processing device based on the user input;
wherein the aviation simulation scenario is configured to be provided to an aviation simulator software for executing an aviation simulation.

16. The apparatus of claim 15, comprising instructions to store the aviation simulation scenario.

17. The apparatus of claim 15, wherein the plurality of data sets comprises at least one of meteorological data, aircraft navigation data, airline operations data, airport operations data, aircraft traffic data, and aircraft operations data.

18. The apparatus of claim 15, comprising instructions to provide the aviation simulation scenario to the aviation simulator software for executing the aviation simulation.

19. The apparatus of claim 15, wherein the user input comprises a simulation time of day restriction, an airspace restriction, an airport setting, an aircraft restriction, a precision restriction, a simulation data restriction, a data source definition, a data source format, outputs for the aviation simulation scenario, a metrics calculation to be performed, a visualization to be produced, or some combination thereof.

20. The apparatus of claim 15, wherein the aviation simulation scenario comprises a plurality of output data files.
